(19) United States
(12) Patent Application Publication
(10) Pub. No.: US 2022/0400163 A1
(43) Pub. Date: Dec. 15, 2022

(54) METHOD AND SYSTEM TO EXECUTE TALPS USING DISTRIBUTED MOBILE APPLICATIONS AS PLATFORMS

(71) Applicant: Kevin D. HOWARD, Mesa, AZ (US)

(72) Inventor: Kevin D. HOWARD, Mesa, AZ (US)

(21) Appl. No.: 17/893,137

(22) Filed: Aug. 22, 2022

Related U.S. Application Data
(63) Continuation-in-part of application No. 16/932,756, filed on Jul. 18, 2020.
(60) Provisional application No. 63/235,794, filed on Aug. 22, 2021.
(60) Provisional application No. 62/875,847, filed on Jul. 18, 2019.

(51) Int. Cl. H04L 67/00; H04L 67/10; H04L 67/568; H04L 67/12

(52) U.S. Cl. CPC H04L 67/34; H04L 67/10; H04L 67/568; H04L 67/12; G06Q 20/322

(57) ABSTRACT

System, methods, and computer programs for executing time-affecting linear pathways (TALPs) using distributed mobile applications as platforms. The systems, methods, and computer programs can use currently unused mobile device compute cycles for commercial-grade computation based on TALPs. TALPs can take the place of software functions, modules, and software applications that are provided for the analysis of customer data. TALPs can be used to perform strong parallel processing.

### RELATED APPLICATIONS

This application is a Continuation-In-Part of U.S. patent application Ser. No. 16/932,756, filed Jul. 18, 2020, which claims priority to and the benefit of U.S. Provisional Patent Application No. 62/875,847, filed Jul. 18, 2019, and this application further claims priority to and the benefit of U.S. Provisional Patent Application No. 63/235,794, filed Aug. 22, 2021; with each of the referenced applications and disclosures hereby fully incorporated herein by reference.

### TECHNICAL FIELD

The present invention relates generally to computer systems and, more particularly, to systems, methods, and computer programs for executing TALPS using distributed mobile applications as platforms.

### BACKGROUND

Software applications currently are associated with income generation in one of three ways: free with no income generated, free with in-application purchases, or direct application purchase/rent. Free applications come in four types: with the purchase of something else (typically hardware), for a limited time period, without the ability to sell the application, or with no restrictions.

Currently, developers lose up to thirty percent of their potential earnings to the platform owners. The mechanism for extracting the value is typically the use of the platform to transfer payments to the application developer from the user after the percent fee is taken out. Monetary value is placed into the platform by the user via a credit card or gift card. When a purchase is to be made, the value is subtracted from the platform account and transmitted to the application developer account, allowing the platform to retain a portion of the payment.

As such, there is a need to provide a system and method for a software application to transmit value from the application to the user through the platform.

### SUMMARY OF THE INVENTION

The present invention extends the Mobile Applications to Distributed Platforms (MADP) system capability, such as that disclosed in U.S. Patent Application Publication 2021/0019158, System and Methods to Convert Mobile Applications to Distributed Platforms. The present system's primary purpose is to use currently unused mobile device compute cycles for commercial-grade computation based on time-affecting linear pathways (TALPs). Systems and methods, such as those disclosed in U.S. Patent Application Publication 2020/0210162, Computer Processing and Outcome Prediction Systems and Methods, can be employed with the present invention. TALPs take the place of software functions, modules, and applications that are provided for the analysis of a customer's data. TALPs are used herein to perform strong parallel processing, such as disclosed in U.S. Pat. No. 10,496,514, System and Method for Parallel Processing Prediction. The system of the present invention executes TALPs and can be constructed using TALPs. All patents, patent applications, and publications referenced or identified in this paragraph, and elsewhere above and below, are hereby fully incorporated herein by reference in their entirety.

There is currently no conventional provision for the software application to transmit value from the application to the user through the platform. With the present invention, if there is monetizable work that can be performed on a mobile device such that work payment can be earned outside of the platform, then the use of the mobile device can be paid for by the application developer. That is, rather than the user paying for items in the application through the platform, the application can pay the user for access to the computational capacity of their mobile device(s). Instead of direct payments for processing time, the payment can be in the form of a chance to win cash and/or prizes equal to some percentage of the value earned by the processing. This chance to win acts to incentivize the device owners to allow their computational capacity to be used.

By reversing the payment direction, it is possible to construct a background task that generates value and incentivizes equipment use while managing costs and offering developers a new income stream.

### BRIEF DESCRIPTION OF THE DRAWINGS

The accompanying drawings, which are incorporated herein and form part of the specification, illustrate various embodiments of the present disclosure and, together with the description, further explain the principles of the disclosure and enable a person skilled in the pertinent art to make and use the embodiments disclosed herein. In the drawings, like reference numbers indicate identical or functionally similar elements.

FIG. 1 is a diagram a hybrid ad hoc mobile device network system of the present invention, acting as a server, linked to a traditional rack-mounted or stationing hardware computer system, acting as the client, in accordance with embodiments of the present invention.

FIG. 2 is a diagram showing a MADP system including an internet-based MADP System website on which customers generate work; an internet-based MADP Market website through which the device owner is remunerated; a rack-mounted, internet-attached MADP Client package that can be constructed of TALPs; a set or series of mobile devices, each containing the MADP Server package comprised of a MADP Control class and a MADP Co-Worker class, used together as an ad hoc network; and display screens to accommodate the device owner's control of their mobile device and for system operator to control the MADP System, in accordance with embodiments of the present invention.

FIG. 3 is a diagram showing an example startup sequence between the rack-mounted, internet-attached centralized client system and a set of ad hoc connected mobile devices, in accordance with embodiments of the present invention.

FIG. 4 is a diagram showing an example of a startup sequence between the internet-based MADP System website and the rack-mounted, internet-attached, centralized client system, in accordance with embodiments of the present invention.

FIG. 5 is a diagram showing an example of a mobile device power management system with off-device storage, in accordance with embodiments of the present invention.

FIG. 6 is a diagram showing an example of mobile device external power available tracking from a Co-Worker mobile device through a Control mobile device and then through the rack-mounted, internet-attached, centralized client system, in accordance with embodiments of the present invention.

FIG. 7 is a diagram showing an example of a typical work session's message flow from the rack-mounted, internet-attached, centralized client system to the Control mobile device then the Co-Worker mobile device and back to the centralized client system, in accordance with embodiments of the present invention.

FIG. 8 is a diagram showing an example of dropped mobile device message flow management from the rack-mounted, internet-attached, centralized client system to the Control mobile device then the Co-Worker mobile device and back to the centralized client system, in accordance with embodiments of the present invention.

FIG. 9 is a diagram showing an example of a forced application abort message flow from the rack-mounted, internet-attached, centralized client system to the Control class of each mobile device to be aborted, in accordance with embodiments of the present invention.

FIG. 10 is a diagram showing an example of the message flow that propagates new TALPs used for analysis from the rack-mounted, internet-attached, centralized client system to a set of ad hoc connected mobile devices, in accordance with embodiments of the present invention.

FIG. 11 is a diagram showing an example of the message flow that moves payment information from the rack-mounted, internet-attached, centralized client system to the Control class of an active mobile device, in accordance with embodiments of the present invention.

FIG. 12 is an example block diagram of the rack-mounted, internet-attached, centralized client system called the MADP Client (1.0), in accordance with embodiments of the present invention. This diagram shows an example of modules that comprise the MADP Client: MADP Client Transmitter (1.1), MADP Client Receiver (1.2), MADP Client Prepare Data Packets (1.3), and the MADP Client Manage Customer Data and TALPs (1.4).

FIGS. 13A-13B show an example block diagram of the modules of the MADP Client Transmitter (1.1), showing messages to the MADP Server (2.0), screen displays to the system operator, and work results to the MADP website, in accordance with embodiments of the present invention. Data is received from the MADP Client Receiver (1.2), Client Prepare Data Packets (1.3) and various data storage areas.

FIG. 14 is an example block diagram showing messages, data, and modules of the MADP Client Receiver (1.2), in accordance with embodiments of the present invention. Messages are received from the Control Transmitter portion of the MADP Server (2.0). Data is received from the system operator, the MADP System website and the MADP Market website. Data is transmitted to the MADP Client Transmitter (1.1), the MADP Client Prepare Data Packets (1.3), the MADP Client Manage Customer Data and TALPs module (1.4), the MADP Market website and various data storage areas.

FIG. 15 is an example block diagram showing data flow and modules of the MADP Client Prepare Data Packets (1.3), in accordance with embodiments of the present invention. Data is received from various data storage areas, the MADP Client Receiver (1.2), and the MADP Client Manage Customer Data and TALPs (1.4) while data is sent to the MADP Client Transmitter (1.1), MADP Client Manage Customer Data and TALPs (1.4), and a data storage area.

FIG. 16 is an example block diagram showing data and modules of the MADP Client Manage Customer Data and TALPs (1.4), in accordance with embodiments of the present invention. This diagram shows an example of message flows from various data storage areas and the MADP Client Receiver (1.2) while sending messages and data to the MADP Client Prepare Data Packets (1.3) and various data storage areas.

FIG. 17 is an example block diagram showing MADP Server (2.0) sending messages to the MADP Client (1.0) and the MADP Server Co-Worker (2.2) while receiving data from the device owner and messages from the MADP Client (1.0) and the MADP Server Co-Worker (2.2), in accordance with embodiments of the present invention.

FIG. 18 is an example block diagram showing MADP Server Control (2.1) receiving messages and data from the device owner, the MADP Client (1.0) and the MADP Server Co-Worker (2.2) while sending data to various data storage areas, in accordance with embodiments of the present invention.

FIG. 19 is an example block diagram showing the MADP Server Control Transmitter (2.1.1) receiving data and messages from various data storage areas, the device owner, the MADP Server Control Receiver (2.1.2), and the MADP Server Co-Worker Receiver (2.2) while sending messages to the MADP Client Receiver (1.2) and the MADP Server Co-Worker Receiver (2.2), in accordance with embodiments of the present invention.

FIG. 20 is an example block diagram showing the MADP Server Control Receiver (2.1.2) receiving data and messages from various data storage areas, various device hardware, the MADP Client Transmitter (1.1), and the MADP Server Co-Worker Transmitter (2.2) while sending data to various data storage areas and the MADP Server Control Transmitter (2.1.1), in accordance with embodiments of the present invention.

FIG. 21 is an example block diagram showing the MADP Server Co-Worker (2.2) receiving messages from MADP Server Control Transmitter (2.1.1) while sending data to various data storage areas and messages to the MADP Server Control Receiver (2.1.2), in accordance with embodiments of the present invention.

FIG. 22 is an example block diagram showing the MADP Server Co-Worker Transmitter module (2.2.1) receiving messages from the MADP Server Co-Worker Receiver (2.2) and sending messages to the MADP Server Control Receiver (2.1.2), in accordance with embodiments of the present invention.

FIG. 23 is an example block diagram showing the MADP Server Co-Worker Receiver (2.2.2) receiving messages from the MADP Server Control Transmitter (2.1.1) and sending data and messages to various data storage areas and the MADP Server Co-Worker Transmitter (2.2.1), in accordance with embodiments of the present invention.

### DETAILED DESCRIPTION OF PREFERRED EMBODIMENTS

The present invention uses currently unused mobile device compute cycles for commercial-grade computation based on time-affecting linear pathways (TALPs). TALPs take the place of software functions, modules, and applications that are provided for the analysis of a customer's data. TALPs are used herein to perform strong parallel processing. The system of the present invention executes TALPs and can be constructed using TALPs. Further, any of the following concepts or teachings can be employed or combined, all or in part, with any or all of the other described systems, methods, and/or embodiments. All patents, patent applications, and publications referenced or identified herein are fully incorporated herein by reference in their entirety.

Useful applications, such as mobile applications (e.g., direction routing, text messaging, etc.), mobile games, and eBooks are very popular. These useful mobile applications and games can be considered attractants for use of the devices. The attractive applications can carry a payload consisting of a background, or hidden (cached) application, and the systems and methods of the present invention make it possible to use some of the billions of idle compute cycles while the attractive application is executing the various applications (e.g., mobile applications). Attractive applications are linked to the system of the present invention and are configured to carry a payload of TALPs, e.g., a cached set of associated TALPs. As such, processing occurs at the mobile device such that idle compute cycles of the mobile device are used by the cached set of associated TALPs while the attractive application is executing.

Various devices or computing systems can be included and adapted to process and carry out the aspects, computations, and algorithmic processing using TALPs, as detailed in incorporated U.S. Patent Application Publication 2020/0210162, combined with the systems and methods of the present invention. Computing systems, devices, or appliances of the present invention may include a computer system, which may include one or more microprocessors, one or more processing cores, and/or one or more circuits, such as an application-specific integrated circuit (ASIC), field-programmable gate arrays (FPGAs), graphics processing units (GPU), general purpose graphics processing units (GPGPU), etc. Any such device or computing system is defined as a processing element (P.E.) herein. A server processing system for use by or connected with the systems of the present invention may include a processor, which may include one or more P.E.s.

Further, the devices can include a network interface or a bus system in cases where the P.E.s are within the same chip. The network interface is configured to enable communication with a communication network, other devices and systems, and servers, using a wired and/or wireless connection.

The devices or computing systems may include memory, such as non-transitive, which may include one or more non-volatile storage devices and/or one or more volatile storage devices (e.g., random access memory (RAM)). In instances where the devices include a microprocessor, computer-readable program code may be stored in a computer-readable medium or memory, such as but not limited to magnetic media (e.g., a hard disk), optical media (e.g., an OVO), memory devices (e.g., random access memory, flash memory), etc. The computer program or TALP code can be stored on a tangible, or non-transitive, machine-readable medium or memory. In some embodiments, computer-readable program code is configured such that when executed by a P.E., the code causes the device to perform the steps described above and herein. In other embodiments, the device is configured to perform steps described herein without the need for code.

It will be recognized by one skilled in the art that these operations, algorithms, logic, method steps, routines, sub-routines, and modules may be implemented in software, in TALPs, in firmware, in special purpose digital logic, and any combination thereof without deviating from the spirit and scope of the present invention as recited within the claims attached hereto.

The devices, appliances, or computing devices may include an input device. The input device is configured to receive an input from either a user (e.g., admin, user, etc.) or a hardware or software or TALP component as disclosed herein in connection with the various user interface or automatic data inputs. Examples of an input device include data ports, keyboards, a mouse, a microphone, scanners, sensors, touch screens, game controllers, and software or TALPs enabling interaction with a touch screen, etc. The devices can also include an output device. Examples of output devices include monitors, televisions, mobile device screens, tablet screens, speakers, remote screens, screen less 3D displays, data ports, HUDs, etc. An output device can be configured to display images, media files, text, or video, or play audio to a user through speaker output.

The term communication network includes one or more networks such as a data network, wireless network, a telephony network, or any combination thereof. It is contemplated that the data network may be any local area network (LAN), metropolitan area network (MAN), wide area network (WAN), the internet, cloud computing platform, or any other suitable packet-switched network, such as a commercially owned, proprietary packet-switched network, e.g., a proprietary cable or fiber-optic network. In addition, the wireless network may be, for example, a cellular network and may employ various technologies including global system for mobile communications (GSM), internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WIFI), satellite, mobile ad-hoc network (MANET), and the like.

TALP decomposition allows for the generation of time-prediction polynomials that approximate time-complexity functions, advanced speedup and automatic dynamic loop-unrolling-based parallelization for each TALP. This technology uses the approximated time-complexity and space-complexity functions to join the outputs of existing processes to the inputs of the TALPs, enhancing the functionality of the existing application. To be useful, these techniques are combined with various error boundary management and modeling techniques to allow existing systems to be automatically upgraded.

A TALP is an execution pathway through an algorithm or software code which includes looping structures. TALPs allow for the direct and automatic selection of a pathway through an algorithm or software code via the examination of the values of input non-loop-control variable attributes. Time prediction for TALPs occurs through varying the input loop control variable attributes and generating a time prediction polynomial. This means that examining the values of input loop control variable attributes is enough to know the processing time of a TALP.

The output value prediction of a TALP occurs through varying the attribute domain of the input variable attributes that affect output values forming an output prediction polynomial. This means that it is possible to know the output values of a TALP through the examination of the input variables. In order to generate the various polynomials used by a TALP, the separate input variable attributes contributions time or output are automatically generated. Thus, the optimization of software codes, including the elimination of control statements and the identification and manipulation of key variables for either time or output values, can be automatically performed using TALPs and their associated analytical tools. Since processing time for a TALP can be manipulated through changes in input variable attribute values, automatic strong parallelization can be performed using TALPs.

Work for a computer algorithm executing on a particular piece of computer hardware is the amount of processing time the algorithm's execution requires. Since a TALP automatically determines the effect of changing input variable attributes on processing time, it is possible to decompose the input variable attribute values into a set of parallel attributes simultaneously executing on multiple TALPs, with the total processing time being the processing time of any of the parallel executing TALPs plus any time required to agglomerate the values for the final answer. In addition, TALPs make it possible to automatically identify when cross-communication between the multiple simultaneously executing TALPs must take place along with what kind of cross communication must be used. Thus, the ability to detect when parallel processing will yield a significant decrease in processing time can be automatically detected and the automatic parallelization of the code performed, using TALPs.

The present invention uniquely applies these attributes and TALP techniques for a distributed mobile data processing system.

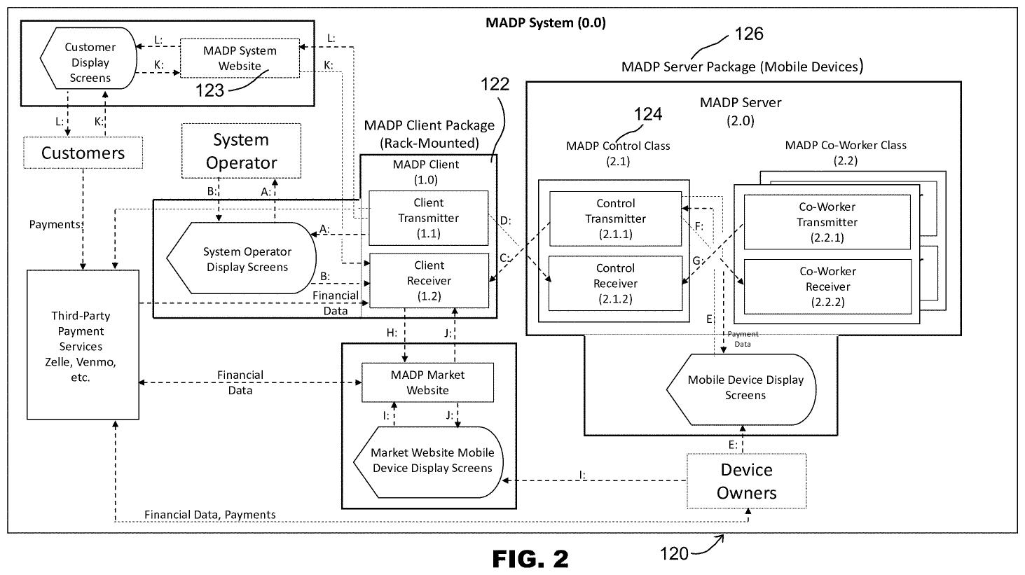

There are various symbols provided with the various figures. For example, for FIGS. 2, 12, 17, 18, and 21, there are capital alphabetical characters followed by colons— (e.g., A:, F:, . . . and so on). These letters symbolize that the following text strings replace the letters because the replacement strings are too long to fit in the figures.
A: (Display Screen Data) Server, Work Status, Software Definition, System Login Status.
B: (Screen Data) System Operator Registration, System Operator Registration Verification, System Operator Login, New Work Definition, Payment, Software Data, Drop Session.
C: (Messages) Server Ready-to-Work, Payment Request, Server Registration, Server Payment Subscription, Server Work-Power Set Up, Server External Power Available, Session Open, Expense Data, Link Applications, I'm Alive, Session Work Received, Session Work Response, Abort Complete, Software Propagated, Server Registration Verification, Dropped Session Complete, Market Request.
D: (Messages) Start Session, Session Work, Payment Data, Market Data, New Analysis Software, Market Request Received, Expense Data Received, Server Registration Received, Server Registration Verification Received, Server Payment Subscription Received, Ready-to-Work Listed, Server Work-Power Set Up Received, Server External Power Available Received, Link Applications Received, Dropped Session, Are You Alive, Abort.
E: (Screen data) Server Activation, Server Registration, Link Applications, Server Payment Subscription, Market Request, Payment Request, Expense Data, Server Registration Verification, Server Work-Power Set Up.
F: (Messages) Work Software, Work, Are You Alive, Work Response Received, Abort, Co-Worker External Power Available Received.
G: (Messages) Work Received, I'm Alive, Work Response, Work Software Received, Abort Received, Co-Worker External Power Available.
H: (Data) Mobile Applications to Distributed Platforms (MADP) Client Receiver invokes Market website with connection to current mobile device and transfers initial market data and expense data for that current mobile device.
I: Mobile device owner interacts with the Lottery Chance Users Market and the Lotteries screens.
J: (Data) Market website displays updated lottery chance and/or auction data to the device owner, transfers that data to the MADP Client Receiver, and transfers control back to MADP Client Receiver.
K: (Data) Data Processing Sales, Customer Registration and Login.
L: (Data) Work results.

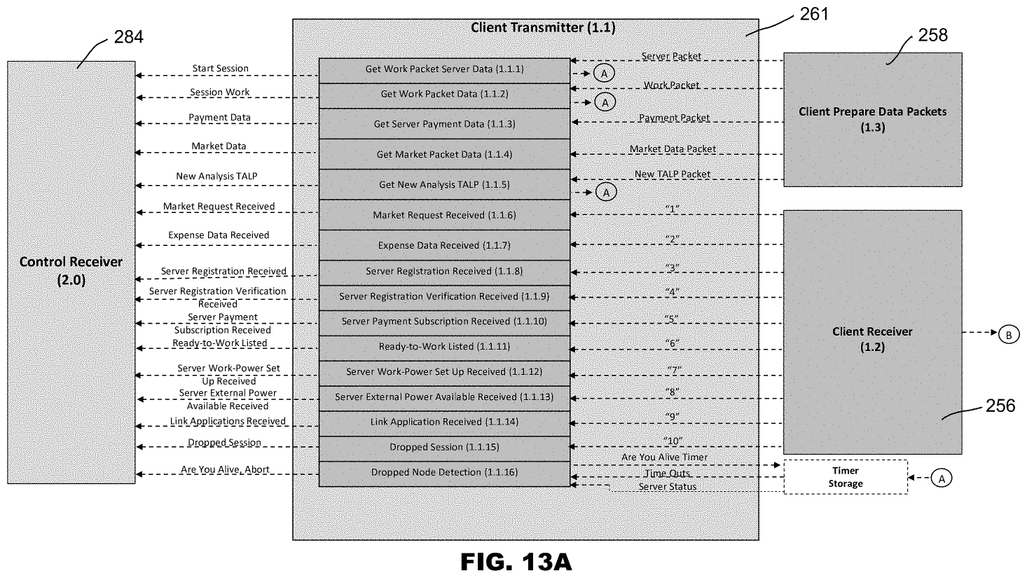

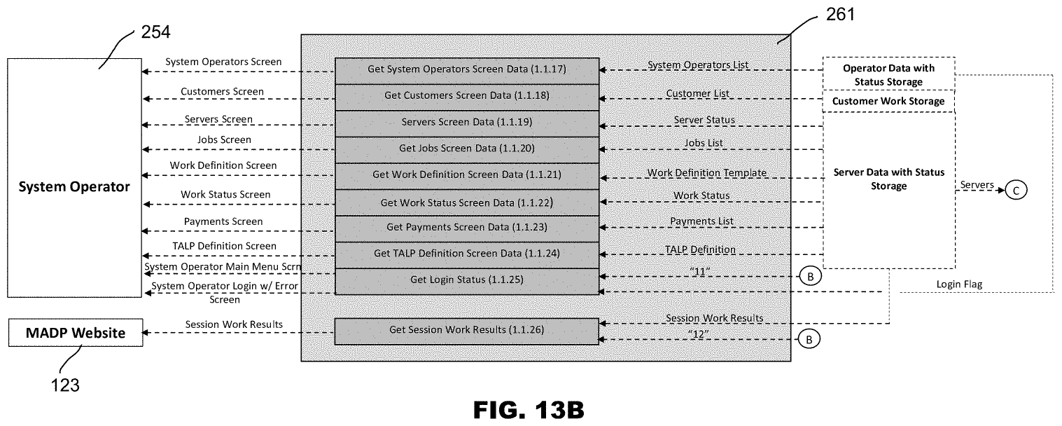

Further, the block diagrams include parenthetical dot numbers, e.g., (0.0) or (2.2.2). These parenthetical numbers are the work breakdown numbers of the indicated portion of the system. Numbers with larger dot numbers represent processes that are within lower dot number items. For example, 2.1 and 2.2 are within an item labeled 2.0 and 2.1.1 is within the item labeled 2.1. In other figures (e.g., FIGS. 13, 14, 19, and 20) there are letters (both capitalized and non-capitalized) that are surrounded by a circle or oval. These enclosed letters are on-page connectors; that is, they connect one portion of a diagram to another portion of that same diagram. They are used to decrease the visual clutter on the diagram. Finally, quoted letters or numbers found on lines within the figures represent the exact data flowing between items.

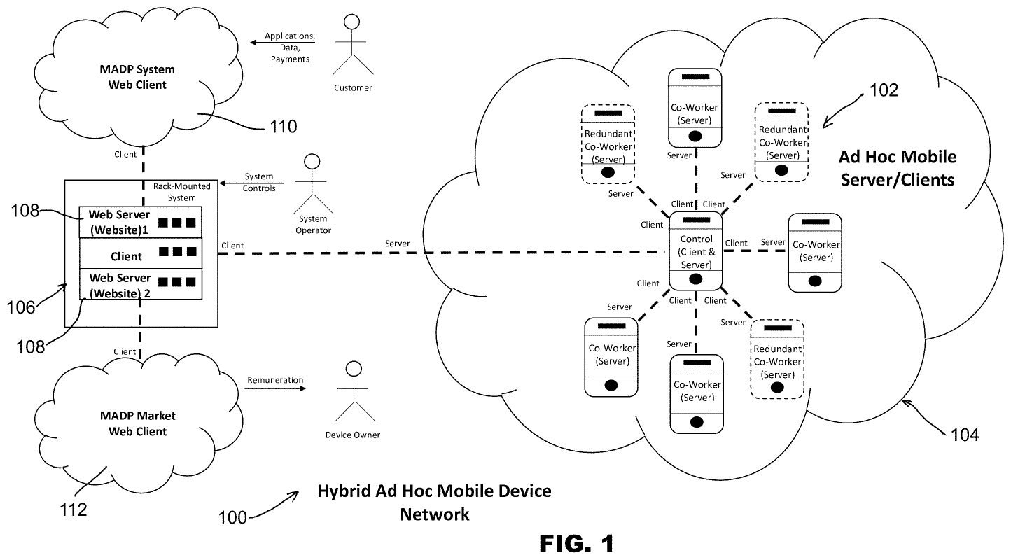

FIG. 1 details a hybrid ad hoc mobile device network system 100 of the present invention, in accordance with various embodiments. The system 100 includes networked ad hoc mobile server/clients acting primarily as a server and a rack-mounted or stationary computer client system with a MADP system web client and a MADP market web client. This is the opposite of how traditional client/server systems work, where the lower-performing system component (in this case, the mobile devices) acts as a client to utilize the capabilities of a higher-performing system component acting as the server (in this case, the rack-mounted system). The ad hoc server portion of the system is also a client/server system whereby at some point in time some mobile devices act as clients and others act as servers. Depending on the current need, which mobile device is a client and which is the server can change. It should be noted that in addition to the rack-mounted system acting as a client to the hybrid ad hoc mobile device network, it simultaneously acts as a webpage server system for two separate websites, one that receives new work from customers and another that dispenses compensation to the owners of the mobile devices of the hybrid ad hoc mobile device network.

The system 100 of FIG. 1 shows the highest-level interaction between multiple mobile devices 102 forming an ad hoc network 104 that is acting as a server and a client in the form of a stationary or rack-mounted system 106, controlled by a system operator. Generally referring to FIG. 1, the web server 108 of the rack-mounted system 104 receives application source codes and/or data from the customer via the MADP System web client 110. Any received application source code is decomposed into TALPS, as detailed in incorporated U.S. Patent Application Publication 2020/0210162, which is fully incorporated herein by reference. TALP identification relates each TALP to a given set of input variable attributes, allowing that TALP to be called automatically given the correct input dataset. TALP time complexity and advanced speedup functions are automatically generated for each TALP. TALP speedup and TALP loop iteration determination along with boundary value analysis (BVA) are used to automatically parallelize each TALP, as detailed in incorporated U.S. Pat. No. 10,496,514, which is fully incorporated herein by reference. The identified parallelized TALPs are sent to Control and then distributed to the Co-Workers and Redundant Co-Workers of the ad hoc mobile device for parallel execution. The Control module of the ad hoc mobile device network is used to define which devices are to be used in the execution of a TALP and how much redundant processing is to be applied to the executing TALP. The Market website is used to remunerate the device owner via the MADP Market web client 112 for the system's use of time on their mobile devices.

FIG. 2 shows a block diagram for the complete MADP system 120, in accordance with various embodiments. The rack-mounted MADP Client package 122 receives application source code and data from a customer via the system website 123. Generally referring to FIG. 2, the application source code is decomposed into TALPs, each with its associated input variable attribute value ranges, time complexity, and advanced speedup in the MADP Client package 122. TALP speedup, loop iteration determination, and BVA are used to also automatically parallelize each TALP, as detailed in incorporated U.S. Pat. No. 10,496,514, in the MADP Client package 122. Parallelized TALPS are transmitted to the MADP Control class 124 of the MADP Server package 126, which generates copies of those TALPs that are then transmitted to the Control's associated Co-Workers. New data along with a request for processing from the customer is received by the MADP Client package 122. This new data is discretized using time complexity polynomials associated with the TALPs, as detailed in incorporated U.S. Pat. No. 10,496,514, in the MADP Client package 122 and transmitted to the MADP Control class 124. The MADP Control class 124 then distributes copies of the discretized data and an indication of which TALPs are to be used in the processing of that data to its associated Co-Workers. Once the data has been processed by the Co-Workers, the results are transmitted back to Control 124, which agglomerates that data. The agglomerated results are returned to the MADP Client package 122, which sends those results to the customer via the MADP System website 123.

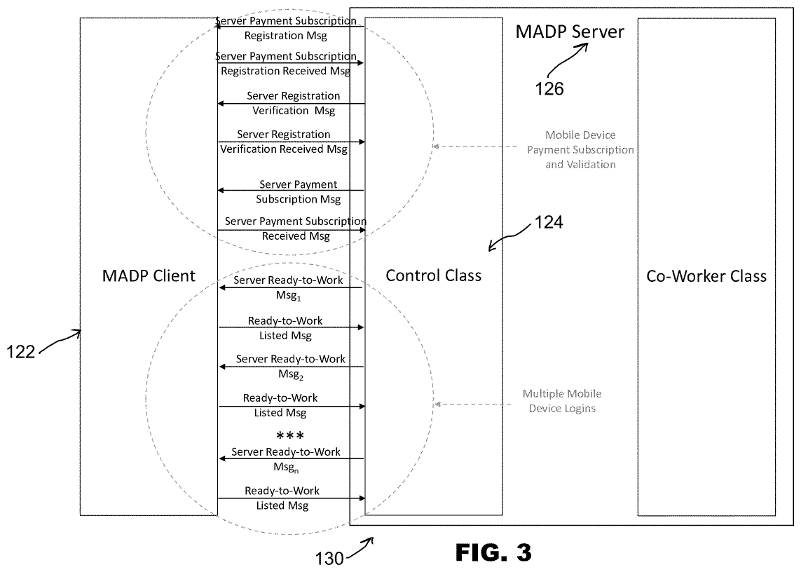

Referring generally to FIGS. 3-11, information flows from the MADP System website to the MADP Client 122, between the MADP Client 122 and the Control class 124 of the MADP Server 126, and between the Control 124 and the Co-Workers, in accordance with various embodiments. These are message flow diagrams showing message names and the order in which the messages are transmitted and received. First, mobile device owners download the MADP Server package of the MADP System, then complete registration, payment subscription, and availability information. Customer registration is completed followed by payment subscription information. Mobile device owners can manage the use of power management by the system on their device. A mobile device is made available for work and that work is managed by the MADP Client 122, including session drop and abort management and the installation of TALP-based work. Payments and market management are made available to the device owners.

FIG. 3 shows the MADP System startup message flow 130 between the Control class 124 of the mobile device and the rack-mounted MADP Client 122, in accordance with various embodiments. After a device owner registers their device and configures their payment model with the MADP Client 122, they declare their device is ready to work by sending a Server Ready-to-Work message to the MADP Client 122, meaning that device can now receive analysis TALPs and the data that needs to be processed. Once the MADP Client 122 has a sufficient number of mobile devices ready to work, as defined by the system operator, the system is ready to process data coming in as part of a work session.

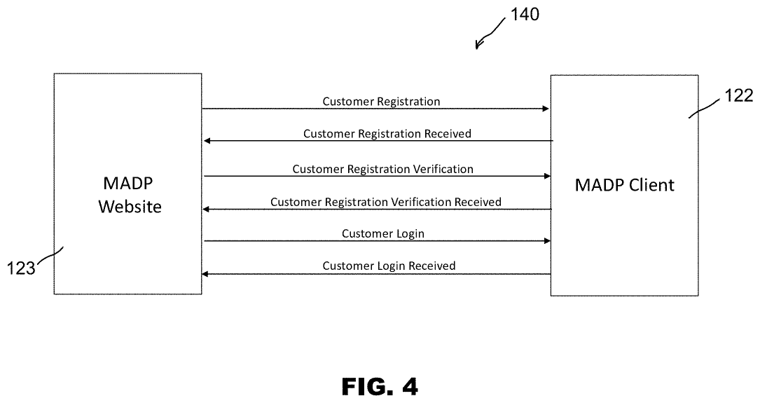

FIG. 4 shows the customer startup message flow 140 between the customer via the MADP System website 123 and the MADP Client 122, in accordance with various embodiments. The customer registers with the system, and once registration is complete, the customer can log in to the system in order to send the application software and data to be processed or just the data to be processed along with an indication of the type of processing to be performed. Regardless, the system indicates the cost of processing, and if accepted, the customer must pay upon completion of the processing in order to receive the processing or work results.

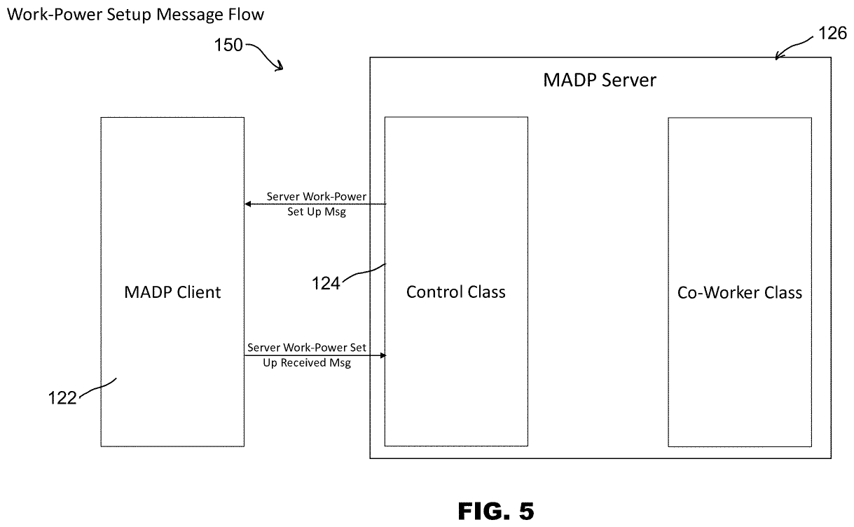

FIG. 5 shows the MADP System work-power setup message flow 150, in accordance with various embodiments. The device owner can select options such as the maximum time per job, the maximum number of jobs received per hour, and the maximum number jobs per day, as well as overrides. An override can include using the mobile device any time the device is plugged in regardless of any other settings. These settings are part of the Server Work-Power Set Up message transmitted from the mobile device Control 124 to the MADP Client 122.

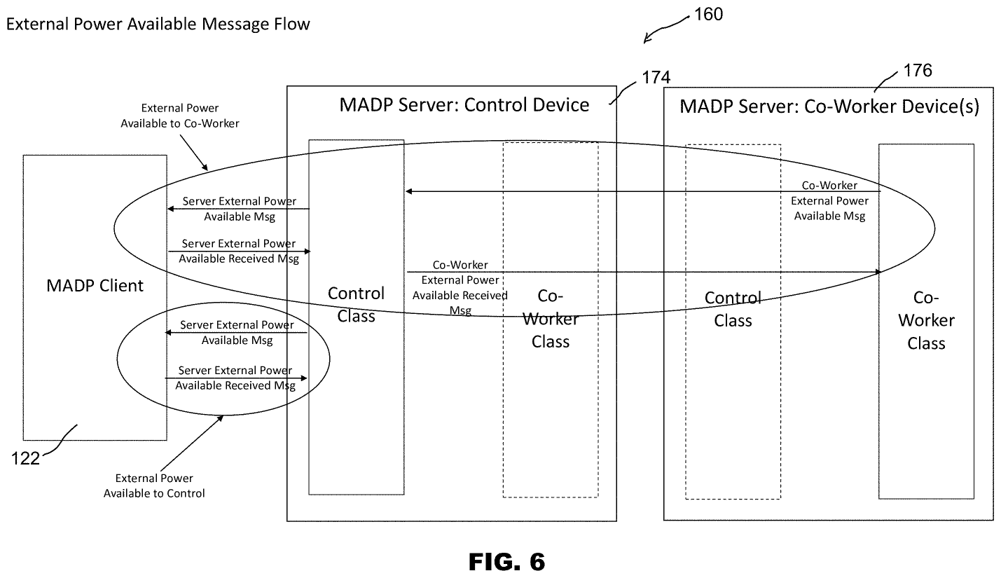

FIG. 6 shows the MADP System external power available message flow 160, in accordance with various embodiments. Plugging in or unplugging a mobile device that is not part of a work session, but is ready to work, automatically causes its Control class to send to the MADP Client 122 a message indicating external power is available. The MADP Client 122 uses that information to determine which work or job should be made available to that mobile device. If a mobile device is part of a work session but not the designated control device 174 of the session, plugging in the device instead causes the Co-Worker class of the Co-Worker device 176 to send a message to the Control class of the Control device indicating external power is available. The message is then relayed to the MADP Client 122 and used to determine whether or not the Co-Worker device can continue to process in an override mode. If a mobile device is part of a work session and is the designated control device 174 of the session, then the message is sent directly to the MADP Client 122 and processing continues.

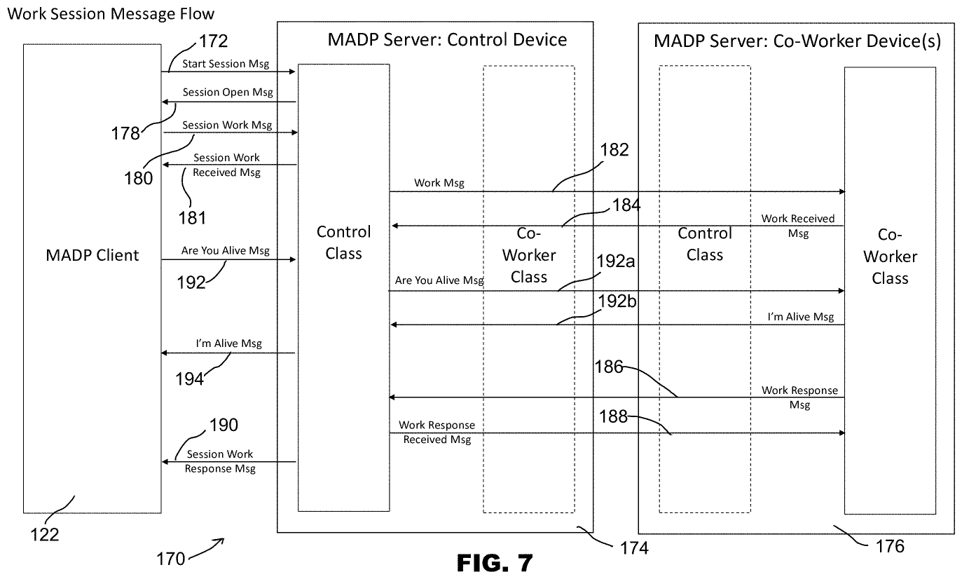

FIG. 7 shows the MADP System work session message flow 170, in accordance with various embodiments. Generally referring to FIG. 7, work for the system is defined as the amount of time it takes to process a given dataset using a given executable TALP performing on a given hardware platform. The dataset and executable TALP are provided to the MADP System by a customer using the MADP System website. The data for the work is decomposed into one or more work packets, using data tiling techniques. The number of work tiles determines the number of server mobile devices required for a work session. Each work packet is comprised of a subset of the given data to be processed, the mobile device to be used to process that data subset, a work session number, and an index to the executable TALP code needed to process the current data subset. Each data subset could be processed using different executable code, increasing the flexibility of the system. A work session is comprised of all data subsets with their associated processing.

The work session starts when the MADP Client 122 sends a mobile device from a Ready-to-Work list of devices, a Start Session message 172, which contains the session code and the session list. The mobile device that receives the Start Session message 172 is considered the Control device 174, and the devices listed in the Session list of the Start Session message are considered Co-Workers 176. At the end of a session, that Session list is deleted and those mobile devices are placed back into the Ready-to-Work list.

The Control mobile device 174 saves the Start Session message 172 with its Session list and returns the Session Open message 178 within the allowed response time. When the MADP Client 122 has received the Session Open message 178, it transmits the Session Work message 180 containing the session code, the TALP index, and the data to be processed to the Control mobile device. Upon the Control mobile device's successful receipt of the Session Work message 178, it returns the Session Work Received message 181.

The Control mobile device 174 for the current session now generates and transmits Work messages 182, each with its own unique Work packet but without the Session list, to the Co-Worker mobile devices 176 that are in the Session list in the Start Session message 172 for actual processing. Upon the successful receipt of the Work message 182, a Work Received message 184 is returned from each active Co-Worker 176 to the Control mobile device 174.

After processing has been completed, each Co-Worker 176 sends a Work Response message 186 back to its associated Control mobile device 174. Upon the successful receipt of a Work Response message 186, the Control mobile device 174 transmits the Work Response Received message 188 back to the current Co-Worker mobile device 176. After receipt of the Work Response Received message 188, the Co-Worker mobile device 176 ends the current work session.

When all Work Response messages 186 have been received from all session-associated Co-Worker mobile devices 176, the Control mobile device 174 generates a Session Work Response message 190 containing the full set of response data and transmits it to the MADP Client 122. Receipt of the Session Work Response message 190 by the MADP Client 122 means that the work has been completed and the session is closed. All mobile devices that were part of the closed work session are returned to the Ready-to-Work list.

Periodically, the MADP Client 122 transmits an Are You Alive (or similar) type message 192 to the MADP Server Control mobile device 174 and awaits its I'm Alive (or similar) type return message 194. If the I'm Alive return message 194 does not appear within an allotted time period, the entire work session is assumed to have dropped, and the MADP Client 122 sends an Abort message to the Server Control device 174 and all Server Co-Worker devices 176 associated with that session.

Upon the receipt of the Are You Alive type message 192 from the MADP Client 122, the Control device 174 in turn transmits an Are You Alive type message 192a to each of its associated Co-Worker devices 176 and awaits a returned I'm Alive type message 194a. If the I'm Alive type message is not received from even one Co-Worker (or one of its redundant Co-Workers) within an allotted time period, then it is assumed to have dropped out of the network. When this condition occurs, the I'm Alive type message is not transmitted from the Control device 174 to the MADP Client 122, and the entire work session is assumed to have dropped.

As the Control device 174 receives the I'm Alive type message from each Co-Worker 176, and redundant Co-Worker, it places the mobile device code of each in the I'm Alive type message that it sends to the MADP Client 122 if the session is still active. The MADP Client 122 removes any dropped mobile devices from both the Session and Ready-to-Work lists.

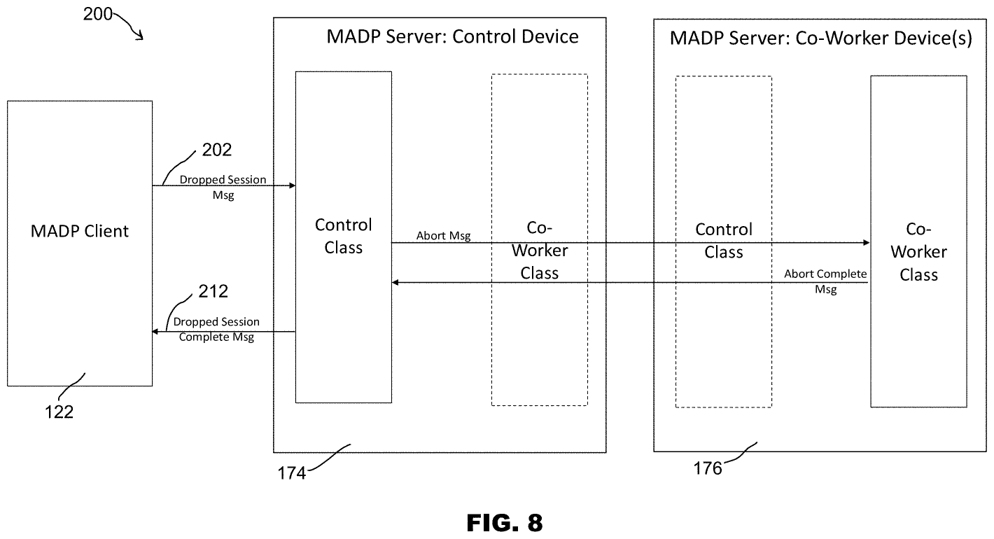

FIG. 8 shows the dropped work session message flow 200, in accordance with various embodiments. The system operator can initiate a message 202 to drop a work session, directing the MADP Client 122 to abort the work session by aborting all of Co-Workers 176 in the work session.

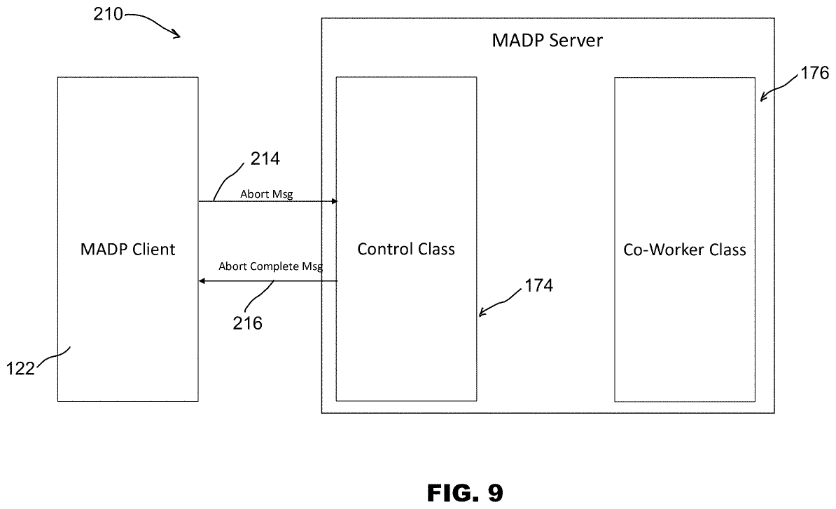

FIG. 9 shows the MADP System dropped work session cleanup message flow 210, in accordance with various embodiments. If the Dropped Session Complete message 212 is not received before a timeout for the Dropped Session message 202, then cleanup for a dropped session is initiated. This means ensuring that all Co-Workers 176 are no longer associated with the session that failed to drop. The MADP Client 122 directly transmits an Abort message 214 to each Control class of each device in the work session, including the Control device 174 and each Co-Worker 176. If the session Abort is successful, each mobile device, including the Control and each Co-Worker, returns the Abort Complete message 216 to the MADP Client.

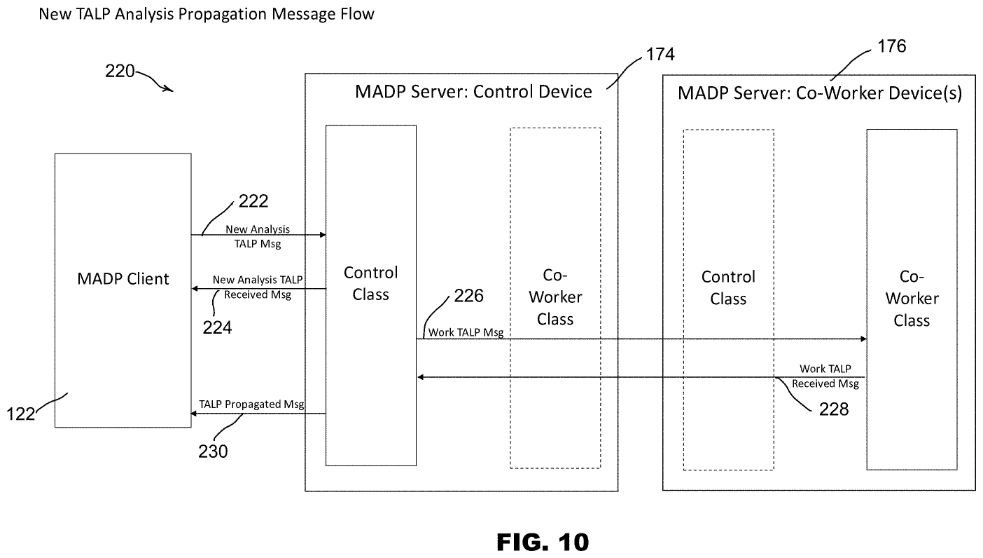

FIG. 10 shows the MADP System new analysis TALP propagation message flow 220, in accordance with various embodiments. The MADP Client 122 receives tested and compiled TALPs called new analysis TALPs, along with a description of the input data format and an index, from the system operator. This information is combined with a list of available mobile devices from the Ready-to-Work list by the MADP Client 122, and the New Analysis TALP message 222 is transmitted to the Control mobile device 174. Upon the successful receipt of the New Analysis TALP message 222, the Control mobile device 174 returns the New Analysis TALP Received message 224.

If the MADP Client 122 has received the New Analysis TALP Received message 224 within a time limit, it awaits the successful propagation of the code. The Control mobile device 174 transmits the new analysis TALP's executable code with its input format and TALP code index, but without the list of Co-Workers 176, to each of its associated Co-Workers, using a newly generated Work TALP message 226. The processing of session work placed on mobile devices requires the pre-staging or propagating of the new analysis TALP onto a sufficient number of those devices.

Upon the successful receipt of the Work TALP message 226, the Co-Worker mobile device 176 returns the Work TALP Received message 228 to the Control mobile device 174. Upon the timely receipt of the Work TALP Received messages 228 from all Co-Workers 176, the Control mobile device transmits the TALP Propagated message 230 to the MADP Client, which tracks those mobile devices.

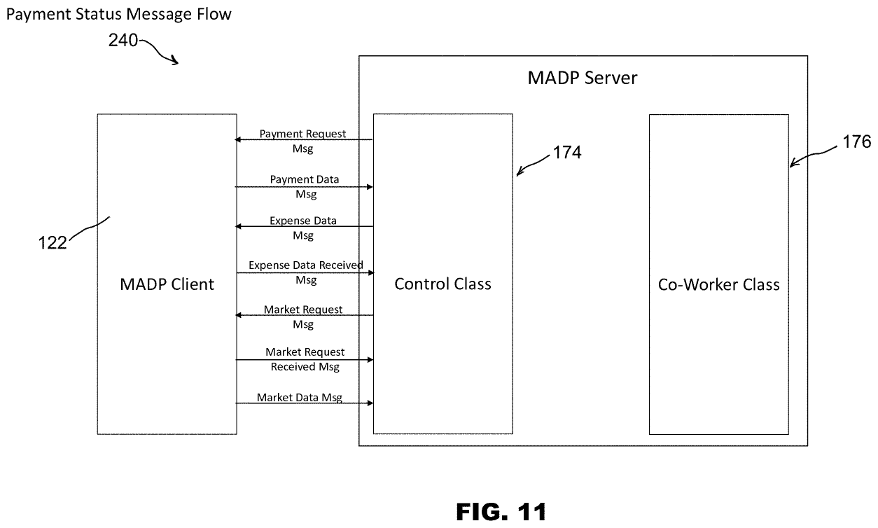

FIG. 11 shows the MADP System payment request message flow 240, in accordance with various embodiments. When a mobile device owner wants to receive a copy of their payment allocation and payment amounts, regardless of whether or not a current session is active, they can request that data from the MADP Client 122. Payment is made either by the direct purchase of game chances on the MADP Market website using the amount of time that the mobile device was used by the system as tokens or by auctioning off earned tokens to other mobile device owners on the MADP Market website.

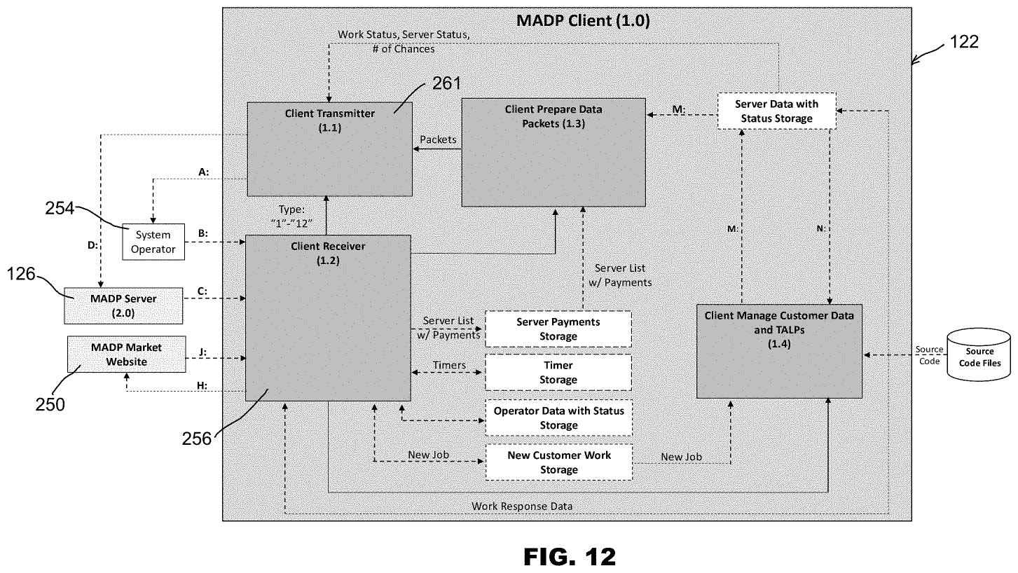

FIG. 12 is a block diagram of the MADP Client (1.0) 122 showing the interaction with the MADP Market Website 250 and the MADP Server 126, and from the system operator 254 to the MADP Client's Receiver module 256, in accordance with various embodiments. The Client Receiver module 256 receives timer data, status data, and customer data with data from the plethora of mobile device messages, source code from customers, data from customers, and MADP Market website data. The MADP client 122 uses the customer source code and data to generate TALPs, whose time complexity polynomials are used to parallelize codes. Any new customer data is discretized and packaged for processing and distribution work to the various associated mobile devices.

FIGS. 13A-13B are block diagrams showing data from the Client Receiver 256, Client Prepare Data Packets 258 and various data stores converted into various messages that are sent to the Control Receiver 284 and data displayed to both the System Operator 254 and on the MADP System website 123, in accordance with various embodiments.

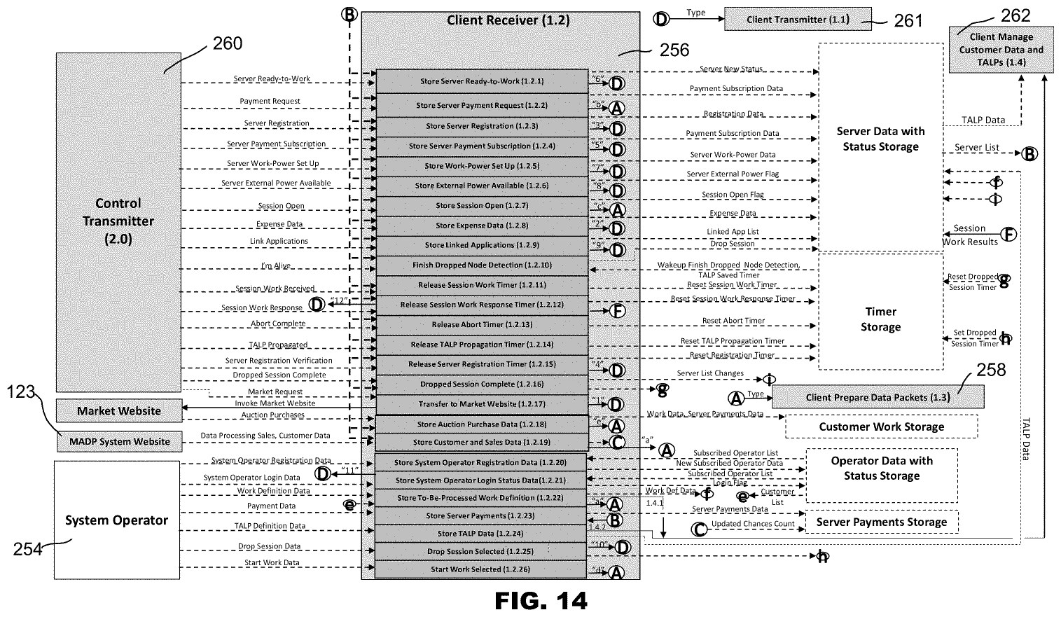

FIG. 14 is a block diagram showing that messages from the Control Transmitter 260 combined with data from the System Operator 254 and MADP System website 123 are used to generate status, timer, work, and payment data as well as data for the Client Transmitter 261, Client Prepare Data Packets 258, and the Client Manage Customer Data and TALPs modules 262, in accordance with various embodiments. It should be noted that system timer information is set by the System Operator, while data packets contain the discretized data from the customer.

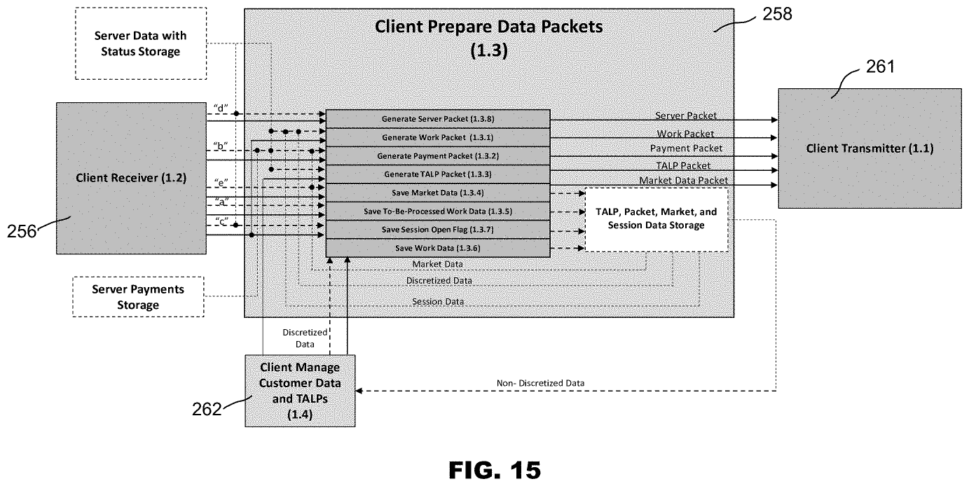

FIG. 15 is a block diagram showing that the Client Receiver 256 uses its generated indicator data (“a” through “e”) to select the correct module within Client Prepare Data Packets 258, in accordance with various embodiments. Raw data from the customer is saved for processing by the Client Manage Customer Data and TALPs module 262. When required, the raw data is discretized and stored as work packets. Any customer selected TALPs are combined in TALP packets, any payment data is combined in Payment packets, and any market data is combined in Market packets.

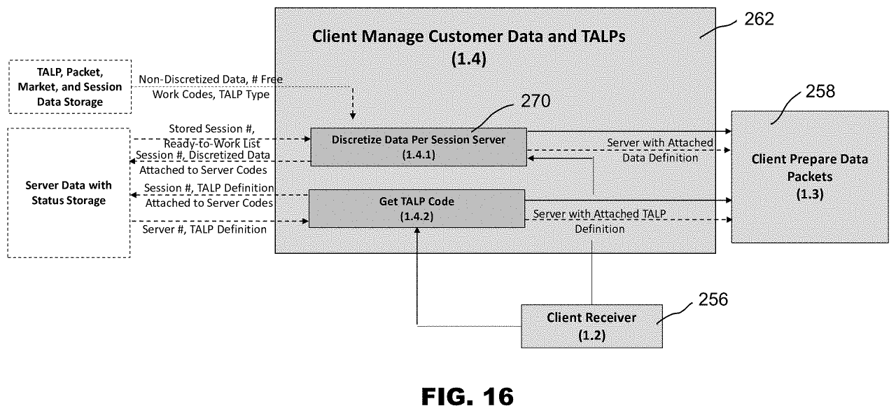

FIG. 16 is a block diagram showing that raw data previously stored is processed by the Discretize Data Per Session Server 270, in accordance with various embodiments. The discretization is a function of the selected TALPs definition (including its associated time complexity) and the number of mobile devices available for work. The selected TALPs, list of available mobile devices and discretized data are then sent to the Client Prepare Data Packets module 258.

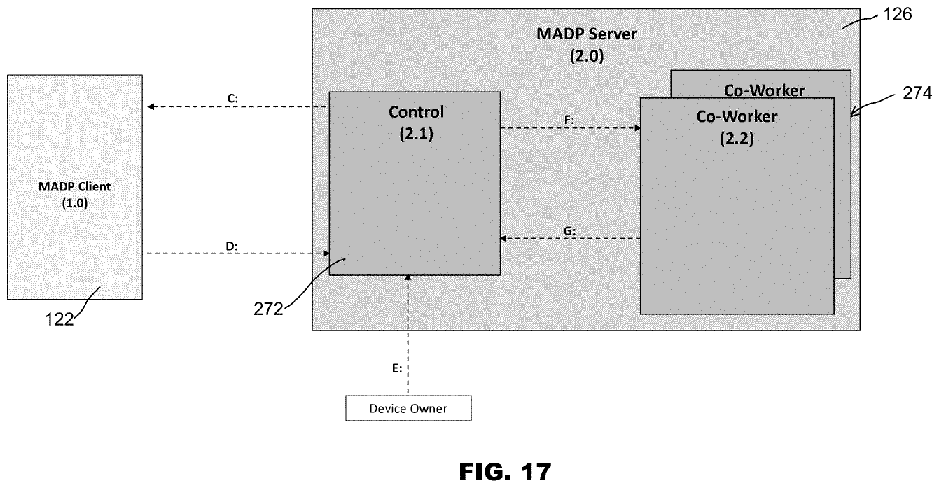

FIG. 17 is a block diagram showing the MADP Server 126 which is downloaded to each mobile device whose device owner wants to allow the system to access, in accordance with various embodiments. There are two primary packages in the MADP Server 126: Control 272 and Co-Worker 274. Control 272 receives data from the device owner, the MADP Client 122, and any associated Co-Worker mobile device 176. The device owner generally gives power management information and power management over-ride conditions, and receives information on any system generated payments. The MADP Client 122 transmits work, session, abort, stay-alive, and TALP information and receives processed data and information on dropped mobile devices. The Co-Worker 274 transmits I'm Alive type signals, Co-Worker External Power Available messages, and work responses. The Co-Worker 274 receives information from the Control package of the associated Control mobile device 174. This information includes TALP definitions, stay-alive signals, work packages, session information, and abort information.

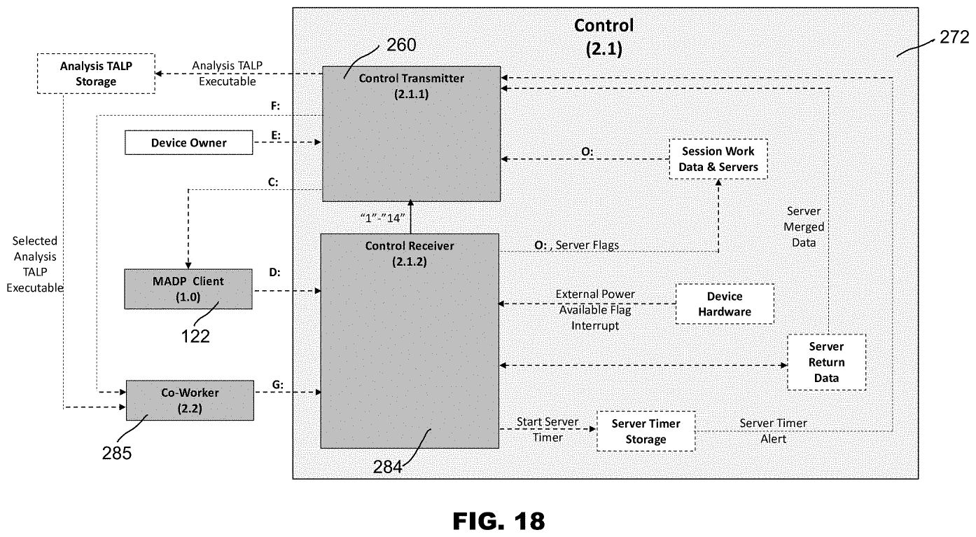

FIG. 18 is a block diagram showing Control 272, which is a part of the application downloaded by the device owner, in accordance with various embodiments. Control 272 is comprised of two components: Control Transmitter 260 and Control Receiver 284. The Control Transmitter 260 gets information from the Control Receiver 284, the device owner, and various data stores and transmits ready-to-work, registration, payment subscription, market request, expense, work power session open, TALP propagated and other messages to the Client Receiver 284. It also sends abort, work TALP, external power, are you alive and other messages to the Co-Worker Receiver 285. The Control Receiver 284 obtains session, payment, TALP, expense, abort, market, and registration messages, among others, from the Client Transmitter 261 and I'm alive, work, and abort from the Co-Worker Transmitter 288. These messages are analyzed, and their data placed into various data stores.

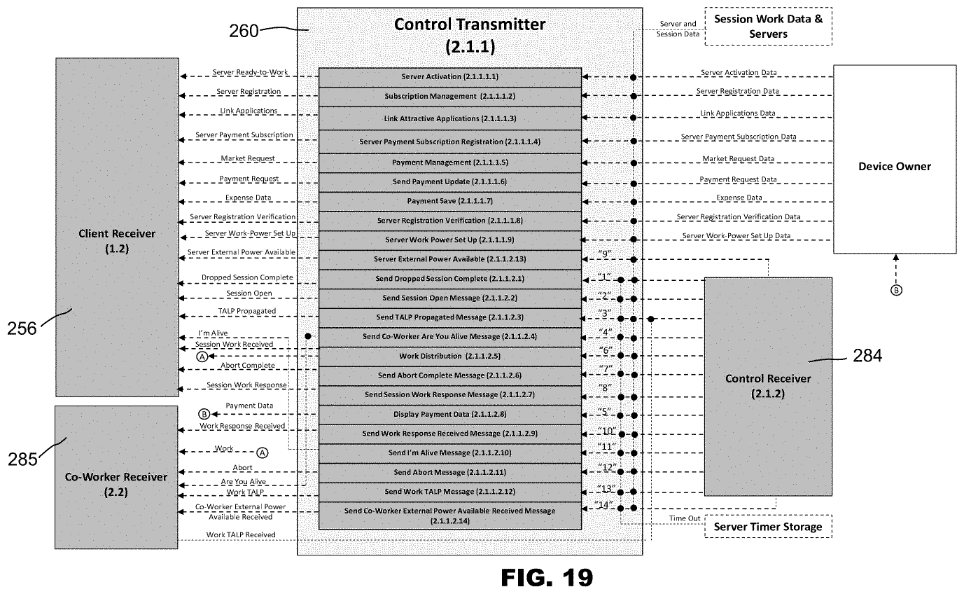

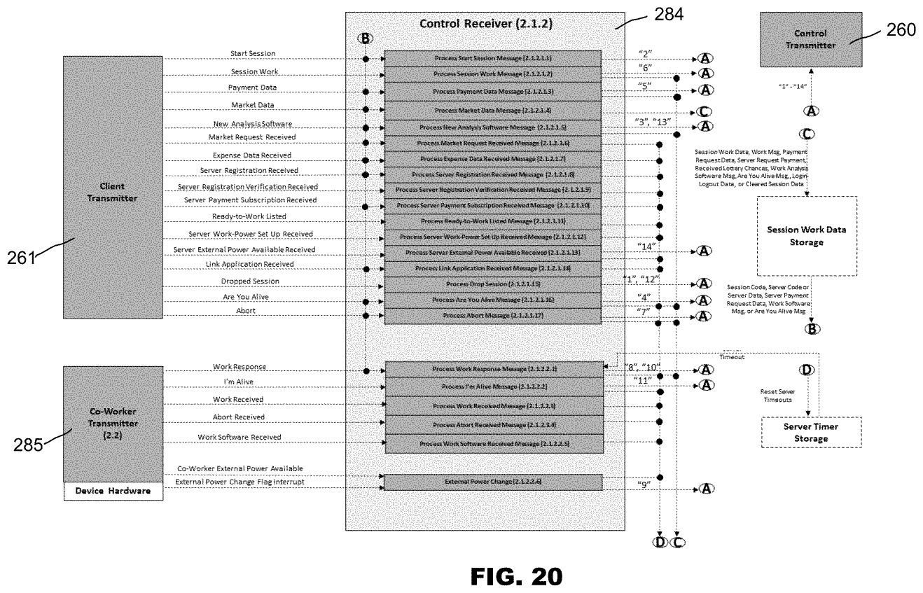

FIG. 19 and FIG. 20 are block diagrams showing the detail of information movement depicted and disclosed in FIG. 18, in accordance with various embodiments.

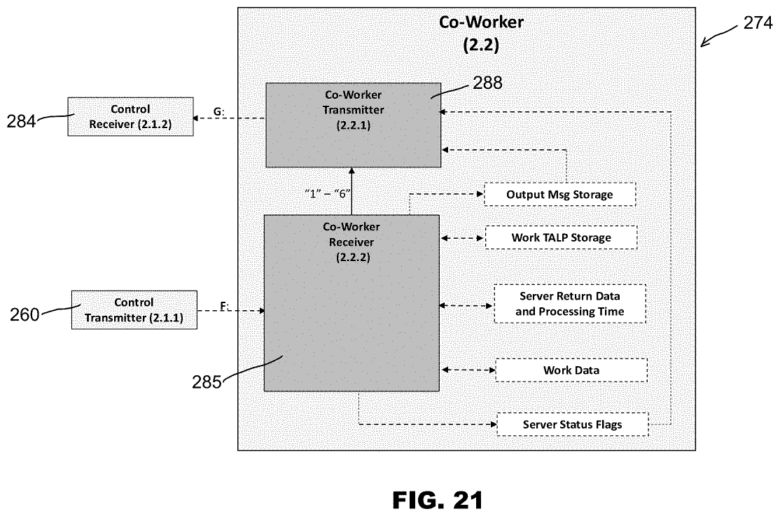

FIG. 21 is a block diagram showing that information is transmitted from the Control Transmitter 260 to the Co-Worker Receiver 285 where that information is stored, as data or TALPs or used to activate the Co-Worker Transmitter 288 for the transmission of messages to the Control Receiver 284 or saved in various local data stores, in accordance with various embodiments.

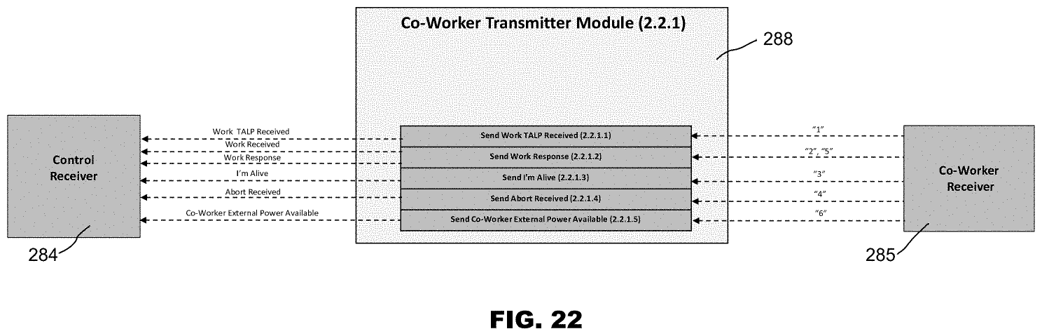

FIG. 22 is a block diagram showing message creation indicators from the Co-Worker Receiver 285 activating various modules used to create messages to be sent to the Control Receiver 284, in accordance with various embodiments.

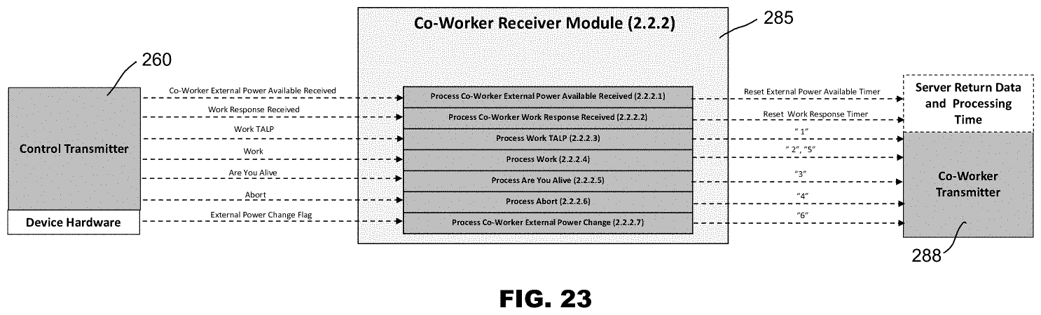

FIG. 23 is a block diagram showing that messages from the Control Transmitter 260 to the Co-Worker Receiver 285 are used to detect that external power is available, respond to received work, receive TALPs, process aborts, process are you alive type messages and save the work and external power status while indicating which messages the Co-Worker Transmitter 288 needs to generate, in accordance with various embodiments.

With various embodiments, the systems and methods of the present invention are configured to and/or capable of one or more of the following:
1) Conversion of standard commercial software into TALPs for distribution onto multiple, ad hoc connected, mobile devices for processing.
2) Automatic parallelization of the generated TALPs and parallel execution of the parallel TALPs on multiple, ad hoc connected, mobile devices.
3) Automatic discretization of input dataset for distribution onto multiple, ad hoc connected, mobile devices for parallel TALP processing.
4) Automatic determination of the processing time of a parallel TALP on multiple, ad hoc connected, mobile devices prior to executing the TALP.
5) Automatic management of parallel TALP component dropouts and aborts on multiple, ad hoc connected, mobile devices,
6) The use of tokens as payment for executing TALPs on multiple, ad hoc connected, mobile devices.
7) The dynamic separation of mobile devices as control devices and/or co-worker devices on a per work session basis.
8) The automatic control of co-worker devices by control devices and control devices by a none-mobile client.
9) The automatic propagation of TALPs using control devices.

Various concepts, systems, and methods of the present invention convert one or more mobile applications on a mobile device to a distributed platform of networked mobile devices, and comprise: providing a cached set of associated TALPs; providing an attractive application, wherein the attractive application is linked to and configured to carry a payload of the cached set of associated TALPs; and processing, at the mobile device, such that idle compute cycles of the mobile device are used by the cached set of associated TALPs while the attractive application is executing.

In various embodiments, the method further includes providing one or more co-worker mobile devices in operative communication with a control mobile device.

In various embodiments, a combination of the control mobile device and the one or more co-worker mobile devices form a MADP server environment.

In various embodiments, a control mobile device includes a control transmitter software module and a control receiver software module in operative communication with a MADP client on a stationary computer hardware system.

In various embodiments, the MADP client includes a rack-mounted system.

In various embodiments, the MADP client includes a client receiver software module and a client transmitter software module executing on a stationary computer hardware system.

In various embodiments, the MADP client manages customer data and the cached set of associated TALPs on a stationary computer hardware system.

In various embodiments, a control mobile device includes a control software module to facilitate processing and messaging between a MADP client and one or more co-worker devices.

In various embodiments, the method further includes providing one or more co-worker devices, wherein the one or more co-worker devices include a co-worker receiver software module and a co-worker transmitter software module.

In various embodiments, the method further includes providing a MADP website in operative communication with a client receiver software module of a stationary computer hardware system.

Various concepts, systems, and methods of the present invention convert a software application into a set of associated, parallel TALPs distributed on an ad hoc network of mobile devices, and comprise: providing a cached set of TALPs to one or more control devices in an ad hoc mobile network; providing a discretized dataset to one or more co-worker devices in an ad hoc mobile network; providing automatic selection of one or more correct TALPs required for processing based on the discretized dataset; providing the automatic selection to the one or more control devices and the one or more co-worker devices of the ad hoc mobile device network; processing, at the one or more co-worker devices, such that idle compute cycles of the one or more co-worker devices are used by the one or more correct TALPs to process the discretized data; and agglomeration of output data values by the one or more control devices to produce a completed solution.

In various embodiments, the method further includes providing the completed solution to a customer.

In various embodiments, a combination of the one or more control devices and the one or more co-worker devices form a Mobile Applications to Distributed Platforms (MADP) server environment.

In various embodiments, the one or more control devices include a control transmitter software module and a control receiver software module in operative communication with a MADP client.

In various embodiments, the MADP client includes a stationary computer hardware system.

In various embodiments, the MADP client includes a client receiver software module and a client transmitter software module.

In various embodiments, the MADP client manages customer data and the one or more TALPs.

In various embodiments, the one or more control devices include a control software module to facilitate processing and messaging between a MADP client and the one or more co-worker devices.

In various embodiments, the one or more co-worker devices include a co-worker receiver software module and a co-worker transmitter software module.

In various embodiments, the method further includes providing a MADP website in operative communication with a client receiver software module of a stationary computer hardware system.

Various concepts, systems, and methods of the present invention process customer data on an ad hoc mobile device using TALP processing, and comprise: providing a website for transmission of the customer data, or a display screen, for a system operator to provide one or more datasets and processing; providing a method to distribute discretized data to co-worker devices in the ad hoc mobile device network; providing a method to agglomerate received partial solutions from parallel, distributed TALPs into a complete solution; and providing a method to return agglomerated solution data from TALP analysis back to the customer.

Any combination of the above concepts or teachings can be jointly combined or formed to a new embodiment. The disclosed details and embodiments can be used to solve at least (but not limited to) the issues mentioned above and herein.

While various embodiments have been described above, it should be understood that they have been presented by way of example only, and not limitation. Thus, the breadth and scope of the present disclosure should not be limited by any on the above-described embodiments or examples. Moreover, any combination of the above-described elements in all possible variations thereof is encompassed by the disclosure unless otherwise indicated herein or otherwise clearly contradicted by context.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order and are not meant to be limited to the specific order or hierarchy presented.

While the present invention has been described in connection with various aspects and examples, it will be understood that the present invention is capable of further modifications. This application is intended to cover any variations, uses or adaptation of the invention following, in general, the principles of the invention, and including such departures from the present disclosure as come within the known and customary practice within the art to which the invention pertains.

It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products.

For purposes of interpreting the claims for the present invention, it is expressly intended that the provisions of 35 U.S.C. § 112(f) are not to be invoked unless the specific terms “means for” or “step for” are recited in a claim.

What is claimed is:

1. A method of converting one or more mobile applications on a mobile device to a distributed platform of networked mobile devices, comprising:
providing a cached set of associated time-affecting linear pathways (TALPs);
providing an attractive application, wherein the attractive application is linked to and configured to carry a payload of the cached set of associated TALPs; and
processing, at the mobile device, such that idle compute cycles of the mobile device are used by the cached set of associated TALPs while the attractive application is executing.

2. The method of claim 1, further including providing one or more co-worker mobile devices in operative communication with a control mobile device.

3. The method of claim 2, wherein a combination of the control mobile device and the one or more co-worker mobile devices form a Mobile Applications to Distributed Platforms (MADP) server environment.

4. The method of claim 1, wherein a control mobile device includes a control transmitter software module and a control receiver software module in operative communication with a MADP client on a stationary computer hardware system.

5. The method of claim 4, wherein the MADP client includes a rack-mounted system.

6. The method of claim 4, wherein the MADP client includes a client receiver software module and a client transmitter software module executing on a stationary computer hardware system.

7. The method of claim 4, wherein the MADP client manages customer data and the cached set of associated TALPs on a stationary computer hardware system.

8. The method of claim 1, wherein a control mobile device includes a control software module to facilitate processing and messaging between a MADP client and one or more co-worker devices.

9. The method of claim 1, further including providing one or more co-worker devices, wherein the one or more co-worker devices include a co-worker receiver software module and a co-worker transmitter software module.

10. The method of claim 1, further including providing a MADP website in operative communication with a client receiver software module of a stationary computer hardware system.

11. A method of converting a software application into a set of associated, parallel time-affecting linear pathways (TALPs) distributed on an ad hoc network of mobile devices, comprising:
providing a cached set of TALPs to one or more control devices in an ad hoc mobile network;
providing a discretized dataset to one or more co-worker devices in an ad hoc mobile network;
providing automatic selection of one or more correct TALPs required for processing based on the discretized dataset;
providing the automatic selection to the one or more control devices and the one or more co-worker devices of the ad hoc mobile device network;
processing, at the one or more co-worker devices, such that idle compute cycles of the one or more co-worker devices are used by the one or more correct TALPs to process the discretized data; and
agglomeration of output data values by the one or more control devices to produce a completed solution.

12. The method of claim 11, further including providing the completed solution to a customer.

13. The method of claim 11, wherein a combination of the one or more control devices and the one or more co-worker devices form a Mobile Applications to Distributed Platforms (MADP) server environment.

14. The method of claim 13, wherein the one or more control devices include a control transmitter software module and a control receiver software module in operative communication with a MADP client.

15. The method of claim 14, wherein the MADP client includes a stationary computer hardware system.

16. The method of claim 14, wherein the MADP client includes a client receiver software module and a client transmitter software module.

17. The method of claim 14, wherein the MADP client manages customer data and the one or more TALPs.

18. The method of claim 11, wherein the one or more control devices include a control software module to facilitate processing and messaging between a MADP client and the one or more co-worker devices.

19. The method of claim 11, wherein the one or more co-worker devices include a co-worker receiver software module and a co-worker transmitter software module.

20. The method of claim 11, further including providing a MADP website in operative communication with a client receiver software module of a stationary computer hardware system.
